(19) United States
(12) Patent Application Publication
(10) Pub. No.: US 2006/0143124 A1
(43) Pub. Date: Jun. 29, 2006

(54) Real time payment transaction system and method

(76) Inventor: Lance A. Ehrke, Brookfield, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/025,895

(22) Filed: Dec. 29, 2004

(51) Int. Cl. G06Q 40/00

(52) U.S. Cl. 705/40

(57) ABSTRACT

A method and system for processing a payment from a customer to a service provider, where the payment is received at a third party merchant and the payment amount is deposited to the customer's account at the service provider. Each customer of the service provider is issued a real time payment (RTP) card that includes identification information concerning the customer and the service provider. The customer presents the RTP card, along with payment, to a third party merchant that operates a credit card terminal or an automated teller machine (ATM). The RTP card information is swiped through the credit card terminal or ATM machine and the payment amount is retained by the third party merchant or ATM machine and credited to the customer's account at the service provider.

### BACKGROUND OF THE INVENTION

The present invention relates to a system and method that allows a customer to pay a bill issued by a service provider using cash, a credit card or debit card from a location remote from the service provider. More specifically, the present invention relates to a real time payment transaction system that allows a customer to pay a bill using cash at a credit card terminal located at a third party merchant and receive a receipt for such payment from the third party merchant.

Currently, about 25%-40% of the United States economy utilizes cash for all of their financial transactions, rather than having or using a credit card or bank account. The term cash throughout this disclosure generally refers to either cash or a check utilized by the customer. As an example, service providers, such as the telephone company, a utility company, cell phone company or other business that has customers that pay a monthly bill for reoccurring services receive a significant number of payments from customers who travel to a bill payment center and either pay the bill in cash or check. Additionally, from 50%-70% of customers mail payments, in the form of a check, to the service provider. These paper payments must be handled by employees or automated processing machines owned by the service provider, which increases the transactional cost to the service provider, which is passed down to the customer.

Many of these service provider customers are what are referred to as unbanked or underbanked member of the economic society. These customers either do not have a credit card or even a bank account. Because these customers are currently not part of the banking industry, bill payment options such as electronic fund transfers, on-line bill payment or other automatic bill processing methods cannot be utilized by these customers.

As can be understood above, it is desirable to bring these unbanked economy participants into the conventional banking system. The inclusion of these unbanked customers into the traditional banking system will increase the number of electronic transactions occurring over the financial network currently in place, while decreasing the cost of each bill payment transaction to the service provider.

### SUMMARY OF THE INVENTION

The present invention relates to a system and method of processing a payment from a customer to a service provider that allows the customer to make such a payment utilizing cash, check, debit or credit cards at a credit card terminal at a third party merchant location, or at an automatic teller machine (ATM).

Initially, the service provider issues a real time payment (RTP) card to its customers for use in making payments to the service provider. Typically, the RTP card includes customer identification information as well as service provider identification information. The service provider identification information includes electronic fund transfer routing information, such as is typically associated with credit cards and debit cards. Each service provider is associated with an issuer bank that issues the RTP cards to the customers of the service provider.

When a service provider customer desires to make a payment on a billing statement from the service provider, the customer presents the RTP card and the payment to a third party merchant that utilizes a credit card terminal. The same function can occur at an ATM machine equipped to receive cash payments from a customer. The credit card terminal at the third party merchant allows the merchant to swipe the RTP card through the card terminal to input the customer information and the service provider information into the EFT network. Alternatively, the customer information and service provider information can be manually entered into the EFT network by the customer by using the RTP card number printed or embossed on the RTP card.

In addition to the customer and service provider information, a payment amount is also entered into the payment terminal at the third party merchant. The payment information, customer identification information and service provider identification information is combined to create a funded transaction packet that is transmitted to the issuer bank for authorization and authentication. Typically, the funded packet is transmitted first to a merchant bank associated with the third party merchant and utilized by the merchant for normal credit card transactions. The merchant bank communicates with the issuer bank information related to the amount of money paid by the customer, as well as the customer identification information and service provider identification information.

Once the issuer bank authenticates and authorizes the transaction, the third party merchant generates a payment receipt to the customer from the third party card terminal. A payment receipt allows both the merchant and the customer to verify the amount of money paid, which provides additional security for the real time payment system of the present invention.

After the payment information has been transferred to the issuer bank, the issuer bank informs the service provider of the payment amount such that the service provider can update a billing database for the customer. Typically, the billing database of the service provider updates the customer with the billing balance on a regular basis so that the customer can monitor the payment amounts made utilizing the RTP card.

In the real time payment system of the present invention, the payments received by the third party merchant are retained by the third party merchant and are used to offset credit payments due to the third party merchant from the merchant bank. The payments due to the third party merchant are a result of debit and credit transactions performed through the merchant card terminal and carried out through the merchant bank. The ability of the third party merchant to retain cash deposits received from RTP card holders increases the cash flow to the third party merchant. Additionally, the third party merchant receives a transaction fee for each transaction that is performed using an RTP card. The transaction fee can be charged to the service provider such that the RTP customer does not pay for the operating costs of the system.

As a result of the real time payment system of the present invention, the service provider can eliminate the use of a lock box service. Typically, the service provider must contract with the bank to provide the lock box service. The use of the RTP card creates electronic funded transaction packets that are received by the issuer bank and thus eliminates the lock box required when payments are received by check through the mail. The use of the real time payment system of the present invention eliminates check processing, check clearing and data entry errors.

In addition to the advantages set forth above, the real time payment system of the present invention also creates a risk offset for the merchant bank and the issuer bank. Specifically, the real time payment system of the present invention creates funded electronic transactions that can be used to offset other credit transactions received by the merchant bank and the issuer bank. The funded transactions reduce the amount of discount fees paid by the participating banks.

### BRIEF DESCRIPTION OF THE DRAWINGS

The drawings illustrate the best mode presently contemplated of carrying out the invention. In the drawings:

FIG. 1 is a flow diagram illustrating the operation of the real time payment transaction system of the present invention;

FIG. 2 is a flow diagram illustrating the authorizing process that forms part of the real time payment transaction system of the present invention;

FIG. 3 is a flow diagram illustrating the transaction routing and receipt generation of the real time payment transaction system;

FIG. 4 is a flow diagram illustrating the various parties utilizing and enabling the operation of the real time payment transaction system;

FIG. 5 is an illustration of a sample RTP card; and

FIG. 6 is an illustration of a sample receipt generated by the real time payment system of the present invention.

### DETAILED DESCRIPTION OF THE PREFERRED EMBODIMENT

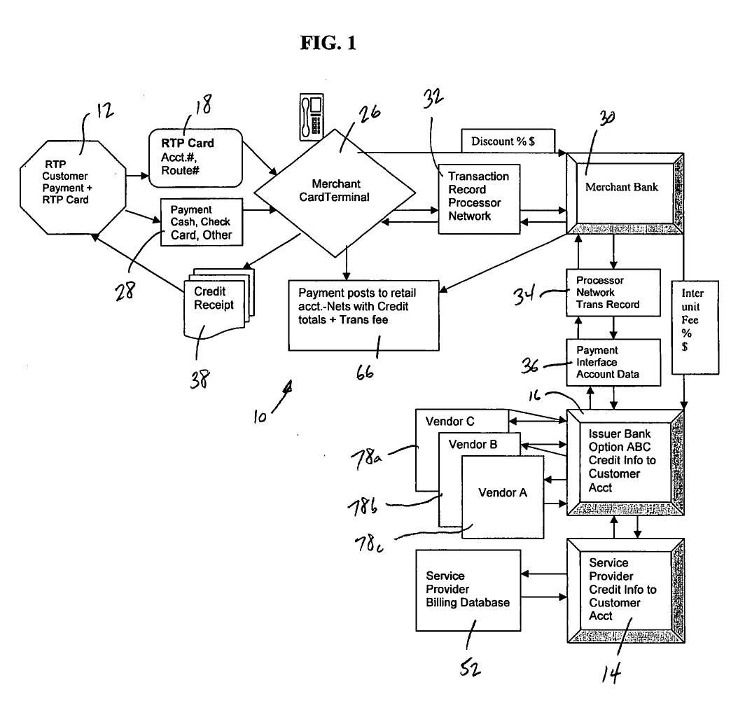

Referring first to FIG. 1, thereshown is a flow diagram of the real time payment system 10 of the present invention. The real time payment system 10 provides a transactional link between a customer 12 and a service provider 14 such that payments due from the customer 12 to the service provider 14 can be carried out using the method of the present invention.

In the contemplated embodiment of the present invention, the service provider 14 can be one of many different types of vendors that provide services or products to individuals. Typically, the service provider 14 provides services on a regular basis and bills for these services on a regular, reoccurring (typically monthly) basis. As an example, the service provider 14 could be a utility, such as gas, water or electric, a telephone company, cable or satellite provider, internet service providers, cell phone provider and many others. Alternatively, the service provider 14 can be other entities such as a charity, auto or home loan company, or any other type of company that issues bills and statements on a reoccurring basis and requires payment from a customer 12.

As discussed previously, a large number of traditional customers pay these reoccurring bills using some type of cash payment, such as actual cash or a check payment. Many of these customers are either unable or unwilling to become part of the financial community by obtaining a credit card or bank account. Thus, these customers must rely upon cash to pay the bills from service providers. The processing of cash payments increases the transactional costs to the service provider and ultimately the customer. Additionally, since many customers pay reoccurring bills using checks sent by mail, the service provider must contract with a bank to act as a lock box for the check payments. The use of a bank as the lock box increases the transactional costs to the service provider. The real time payment system of the present invention addresses the drawbacks of a cash payment system as will be discussed in detail below.

Referring back to FIG. 1, in accordance with the present invention, the service provider 14 is associated with an issuer bank 16 that maintains an account for the service provider. In the embodiment of the invention illustrated in FIG. 1, the issuer bank 16 is a bank or similar organization that typically issues credit or debit cards to an individual or organization. In the embodiment of the invention illustrated, the issuer bank maintains an account for the service provider and issues a series of real time payment (RTP) cards 18 to the individual customers 12 of the service provider 14.

The RTP card 18, as shown in FIG. 5, is an identification card that is provided by the service provider 14 to select numbers of its customers. Typically, the RTP card 18 is the size of a conventional credit card and includes a magnetic strip on the back surface of the card (not shown), similar to conventional credit and debit cards. The RTP card 18 typically includes the service provider's name 19, the RTP card identification logo 21, the customer's name 20 and an issuer bank identification 22. Preferably, the RTP card 18 includes a 16 digit identification number 24. The identification numbers are also contained on the magnetic strip along the back of the RTP card 18. The identification number 24 identifies the service provider and the customer's account with the service provider 14. Specifically, the RTP card 18 includes information on its magnetic strip that includes both customer identification information and identification information relating to the service provider. Such information is used, in a manner to be described below, to identify the customer as well as to provide routing information to the account of the service provider 14 at the issuer bank 16.

The RTP card 18 shown in FIG. 5 is issued by the service provider to a select number of its customers. Since the RTP card 18 is designed to allow the customer to make payments against the customer's account at the service provider, the service provider does not need to perform a credit check or other type of security check on the customer before issuing the RTP card 18. Since the customer can only make payments to the service provider using the RTP card 18, if the RTP card 18 is either lost or stolen, the service provider 14 and issuer bank 16 do not need to worry about canceling the customer's account and dealing with unauthorized charges, such as is the case with a conventional credit card.

Referring back to FIG. 1, assume that the customer 12 having one of the RTP cards 18 has a desire to pay a reoccurring bill from the service provider 14. For example, the customer 12 may have received a bill from the service provider, such as the customer's local electricity company, and desires to pay the electricity bill. In the example of FIG. 1, the customer 12 is a customer that typically pays his or her bills by traveling to an authorized payment branch, such as a convenience store, for the electricity company and paying the bill using cash. The present invention allows the same customer 12 to make the same payments using cash, check, credit card or debit card, yet introduces the customer 12 into the currently available electronic fund transfer banking system.

Initially, the RTP customer 12 must travel to a third party merchant that has a merchant card terminal 26. Typically, the merchant is a business that is qualified to accept credit or debit cards as payment for services. For example, the third party merchant can be a gas station, grocery store, department store or any other location that includes a conventional credit card terminal that can accept credit or debit cards and can provide an automated check processor terminal at the point of sale for check acceptance. Although a conventional credit card swiping terminal is contemplated as being the most preferred embodiment for the merchant card terminal 26, it is contemplated that the merchant card terminal 26 can also be an ATM machine or any other type of card reader that is connected to a commercially available electronic fund transfer system and can process electronic information from the RTP card. Further, the card swipe terminal could be replaced by a data entry device that allows the RTP customer to type in the 16 digit identification number of the RTP card 18. The identification number serves as a routing number for the transaction.

After traveling to the third party merchant, the customer 12 presents the RTP card 18 to the third party merchant. The third party merchant swipes the card through the merchant card terminal 26, which inputs the customer identification information and the service provider identification information. Once the RTP card 18 has been swiped through the card terminal 26, the third party merchant receives a payment 28 from the customer. The payment 28 can be any type of payment the third party merchant 26 is willing to accept. For example, the payment can be cash, check, debit card or even a credit card payment. The amount of the payment 28 is entered by the third party merchant into the card terminal 26 to create a funded transaction packet.

As can be understood above, the amount of payment entered into the merchant card terminal 26 is controlled by the employee of the third party merchant. As will be described in detail below, the amount of payment received by the third party merchant remains at the third party merchant following completion and the balancing of the days transactions. Thus, the integrity of the payment received from the customer is controlled by the employee of the third party merchant. Any mistake made by the third party merchant will directly affect the amount of funds remaining at the third party merchant following the days business.

Once the funded transaction packet is created, the funded transaction packet is transferred to a merchant bank 30 over a commercial electronic fund transfer network 32. The merchant bank 30 is a bank or third party organization that acts on behalf of the bank and may be licensed as a member of a credit card network, such as Discovery, VISA and/or Master Card. The merchant bank 30 maintains a relationship with the third party merchant and handles the credit card, debit card, and cash approval transactions occurring through the merchant card terminal 26. Preferably, the EFT network 32 is provided by one of a number of commercial entities. The EFT network 32 is currently in place and is used to transact millions of financial transactions on a daily basis. The EFT network 32 is a secure transaction system and is utilized by both the third party merchant and the merchant bank 30 in transacting credit card and debit card financial transactions. Thus, the use of the RTP card 18 is simply another type of financial transaction occurring over the EFT network 32.

Once the funded transaction packet is received at the merchant bank 30, the merchant bank 30 utilizes the routing information received from the RTP card 18 to direct the funded transaction packet over the EFT network to the issuer bank 16. The transaction packet creates a transaction record 34 and payment account data 36 as it is being transferred to the issuer bank 16. At the issuer bank 16, the issuer bank authenticates and authorizes the customer identification information and the account status held by the issuer bank 16 for the service provider. After receiving the funded transaction packet, issuer bank communicates with the service provider the amount of payment received and the customer identification information. The service provider 14 typically communicates with its billing database 52 to credit the customer's account the correct amount corresponding to the payment 28 received from the customer 12. The service provider may communicate the balance of the customer's account back to the issuer bank 16.

If the data received from the merchant card terminal 26 is correct and matches a customer account at the service provider 14, issuer bank generates an authentication and acceptance message back to the merchant bank 30. The merchant bank 30 directs this acceptance information to the merchant card terminal 26. Upon receiving authentication and authorization, the merchant card terminal 26 issues a payment receipt 38 that is printed by the merchant card terminal 26 and provided to the customer 12.

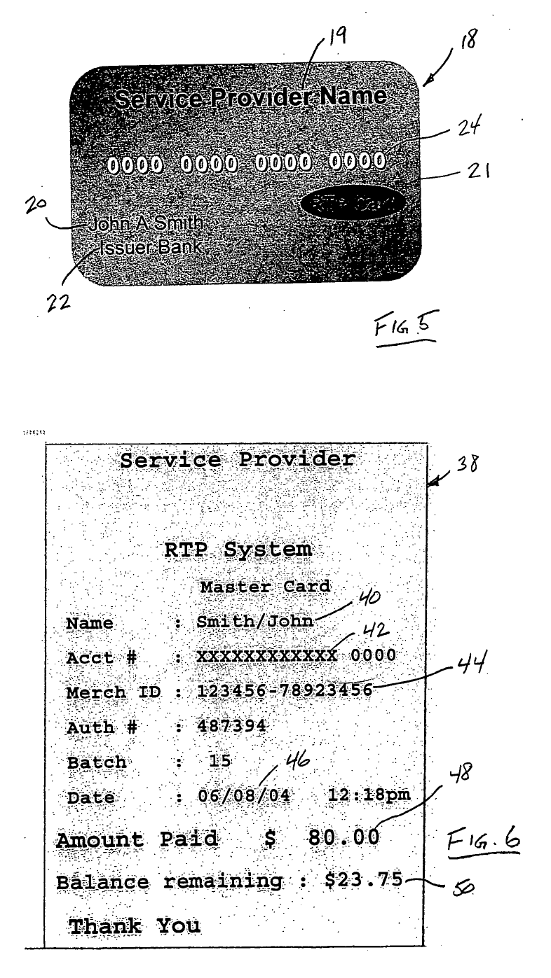

Referring now to FIG. 6, thereshown is a typical payment receipt 38 received by the customer as printed by the third party merchant card terminal 26. The payment receipt 36 includes the customer identification information 40, the customer's account number 42, a merchant identification number 44 and a date of payment receipt 46. The payment receipt 38 includes the amount of payment received 48 and may include the balance 50 remaining on the customer's account. The customer is able to retain the receipt 38 as proof of payment to the service provider as received by the third party merchant.

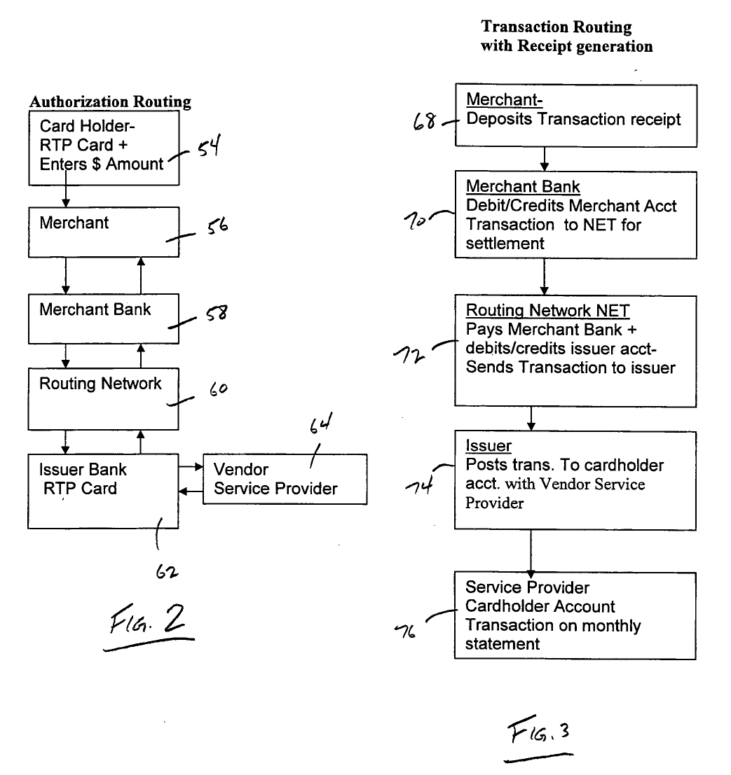

Referring now to FIG. 2, thereshown is another illustration of the approval routing that takes place in the transaction system of the present invention. As discussed, the card holder presents the RTP card in step 54 to the third party merchant 56. The third party merchant, through its card terminal, communicates with a merchant bank in step 58. The merchant bank communicates the funded transaction packet over an EFT network in step 60 to the issuer bank for the RTP card, as illustrated in steps 62. The issuer bank communicates with the service provide 64 to authenticate the customer identification number and account number. If the customer identification number and account number are accurate, the issuer bank credits the customer account and communicates back to the merchant bank and eventually the third party merchant to complete the transaction.

In the preferred embodiment of the invention, the entire approval process illustrated by FIG. 2 will typically take place in approximately 10-15 seconds. The approval process is virtually identical to the approval process of current financial transactions and utilizes the commercial EFT network currently in place.

As discussed above, the real time payment system 10 of the present invention allows a customer 12 to pay cash, or with a credit card or debit card, for any type of payment or bill from any location that includes some type of card reading terminal 26. The card reading terminal 26 is typically used for credit card transactions and does not have to have any association with the service provider. In this manner, a customer having an RTP card 18 can pay reoccurring bills utilizing cash from multiple locations, one of which will be geographically close to the customer at any time. At the same time, the funded transaction from the card terminal 26 enters into the EFT network and increases the volume of transactions over the EFT network. This volume of transactions creates additional revenue streams for the issuer bank, card processor, third party merchant and the merchant bank 30. Additionally, the increase in the number of electronic payments received by the service provider 14 substantially decreases the cost of bill payment processing incurred by the service provider 14. Although the service provider 14 will be required to pay a small transaction fee for each electronic fund transfer, the transaction fee is typically substantially less than the typical cost for receiving and processing cash or check payments.

In the real time payment system 10 shown and described in FIG. 1, the third party merchant that owns and operates the card terminal 26 receives the cash deposits or payments from the customer 12. The cash de posits or payments are retained at the site of the third party merchant. Typically, the third party merchant that operates the card terminal 26 completes a substantial number of credit or debit transactions on a daily basis. Each of these credit transactions are sent to the merchant bank 30 over the EFT network 32. The third party merchant, when settling the credit and debit card transaction for the day, includes the cash deposits or payments received from RTP customers 12 in the total settlement to the merchant bank 30. The third party merchant audit accounts for all of the deposit receipts that are cash, debit and credit. As illustrated in step 66, the merchant bank nets the retail transactions and makes a deposit to the retailer account minus the cash payments made by the RTP customers 12. Thus, the merchant receives cash deposits as an offset for the credit transactions on the same date as the credit transactions. Thus, the merchant is able to receive cash on the same day to offset a portion of the credit transactions carried out by the merchant through the card terminal 26.

In accordance with the present invention, the third party merchant who will receive payment from the customer through the card terminal 26 receives a transaction fee paid to the merchant for handling each of the RTP card transactions. As an example, the merchant will receive a fifty cent transaction fee for each of the transactions the merchant has handled on a daily basis. This transaction fee provides incentive to the merchant to accept payments using the RTP card 18.

Referring now to FIG. 3, thereshown is a flow diagram illustrating the transaction routing within the real time payment system 10 of the present invention. As shown, the initial step 68 requires the merchant to deposit the transaction, typically using the merchant card terminal 26. Once the transaction has been deposited, the information is transferred to the merchant bank in step 70. The merchant bank debits or credits the third party merchant account the amount of the transaction and sends the transaction to the EFT network for settlement. The EFT network routes the information to the issuer bank and credits the merchant bank from the issuer bank in step 72. The issuer bank posts the transaction to the service provider and credits the card holder account, as illustrated in step 74. The service provider will then generate a report, typically on a daily, weekly and/or monthly statement, to report the payments received and amount owed for additional services, as illustrated in step 76.

Referring back to FIGS. 1 and 5, the real time payment system 10 of the present invention is inherently a secure system since the system does not allow unauthorized personnel in possession of the RTP card 18 to withdraw funds from the customer's account. As discussed, each of the RTP cards 18 includes account and customer identification information that only allows the customer 12 to apply payments against an account maintained by its service provider 14. If the RTP card 18 is lost or stolen, the person in possession of the card can only make payment to the customer's account at the service provider 14. During the processing of a payment, both the merchant and the customer are presented with a payment receipt 38 that can be checked by both the merchant and the customer at the time the payment is received and recorded.

Referring back to FIG. 1, the issuer bank 16 can issue RTP cards 18 for not only the service provider 14, but for multiple other vendors 78a, 78b and 78c. Each of the additional vendors 78a-78c operates in the same manner as the service provider 14 in issuing an RTP card to its customers and managing the customer's account through the issuer bank 16 using unique identification numbers.

In an alternate embodiment of the invention, a single RTP card can be created that includes information for multiple service providers. Thus, the single RTP card 18 can be used to make payments to a plurality of different service providers. Typically, the RTP card will be a smart card that includes an embedded chip to direct payment to the proper service provider. Typically, the issuer bank 16 will provide a routing code that is different for each of the plurality of service providers associated with the single RTP card. Typically, the routing ID number is entered by the third party merchant into the merchant card terminal depending upon which of the multiple service providers the customer desires to apply a payment. Since the RTP card 18 does not provide access to the customer's deposit account and cannot act as a credit card, multiple provider identification number (PIN) can be used to identify which of the service providers payment is to be applied. The multiple PIN numbers can be printed on the face of the RTP card or can be applied as a sticker. It is contemplated that each service provider can have a PIN number that is the same for all of its customers.

As discussed previously, the merchant card terminal 26 could also be replaced by a conventional ATM machine. If the merchant card terminal 26 were an ATM machine, the RTP card 18 would initially be inserted into the ATM, which then routes the transaction to the issuer bank 16. Upon authentication, the ATM requests the method of payment, either debit or credit card. Upon selection, the debit or credit card is inserted into the ATM and the ATM authenticates the card and completes the transaction of routing a funded payment packet from the bank account or credit card account to the issuer bank. Alternatively, cash can also be entered into the ATM on selected machines that include the mechanical ability to recognize cash.

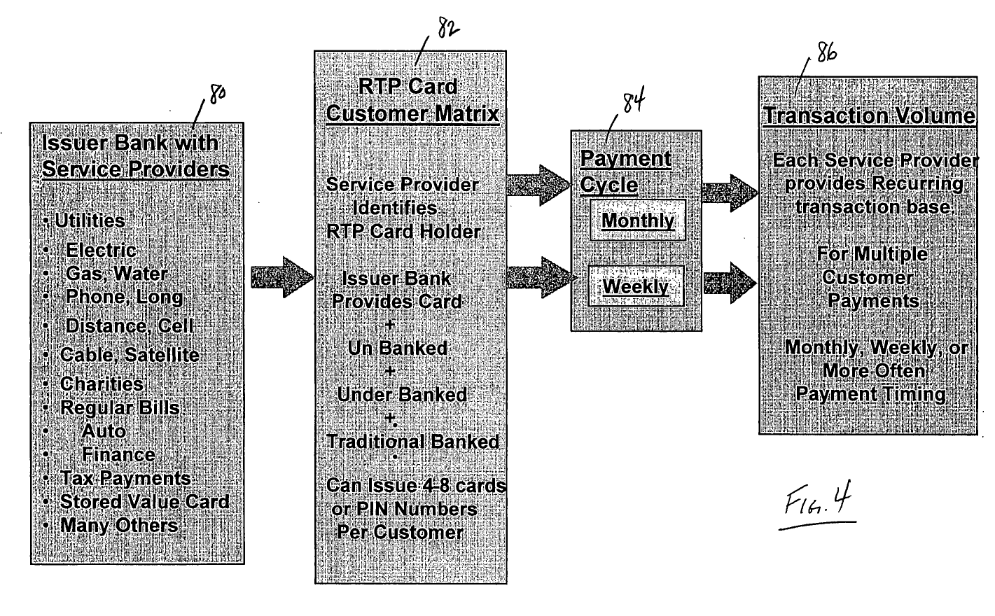

Referring now to FIG. 4, thereshown are various features of the real time payment system 10 of the present invention. As illustrated in block 80, the issuer bank can be associated with multiple different service providers. Block 80 illustrates the proposed types of service providers, such as utilities, charities, and other entities that generate reoccurring bills. Block 82 illustrates the types of customers that utilize the RTP card of the present invention. The RTP card can be given to traditional bank customers, unbanked customers, under-banked customers and any other type of customer that typically makes payments using either cash or credit. It is contemplated that multiple RTP cards can be issued, one for each service provider. Alternatively, a single “smart card” can be issued that includes multiple PIN numbers that allow the customer to select the service provider for payment.

Block 84 illustrates that payments can be made utilizing the RTP card on a monthly, weekly or any other payment cycle. The ability to make payments at multiple cycles allows the customer to control cash flow and allows the service provider to receive payments at more regular intervals.

In addition to the benefits discuss previously, the use of the real time payment (RTP) system of the present invention utilizes the process of creating an electronic transaction (ET) that is initiated at a card terminal 26, an ATM terminal or input on a computer system. This electronic transaction (ET) is “funded” payment process, which links or attaches a cash contribution or a debit or credit card transaction with the electronic transaction (ET) creating a funded electronic transaction (FET). This FET is routed over the electronic finds transaction system.

By routing the FET from the card terminal 26 to the issuer bank 16, and thus to the service provider customer account, the system is transferring finds from the card terminal to the issuer bank. This funded transaction is adding dollars to the EFT network.

Upon receiving the FET, the issuer bank applies the transaction amount to the proper service provider customer account. The dollar amount is available at the issuer bank for the service provider. The issuer bank has use of these funds for several days.

In addition to the RTP system of the present invention, the merchant bank 30 and the issuer bank 16 are also transferring funds from the issuer bank to the merchant bank to the account of a merchant who processes a consumer credit card at the terminal 26. The finds being transferred initiate a discount fee for the risk of borrowing the funds from the issuer bank and transfer the discount fee to the merchant for the account of the consumer who holds the credit card.

Since a typical credit transaction is at risk for payment, it is charged a discount fee as payment to compensate for the risk. The amount of credit transactions in the system is also measurable and amounts to finds flow in the EFT network.

The dollars identified by the RTP FET are the dollar payment amounts in the EFT system that are available to the merchant bank and the issuer bank for a period of time. There is no interest charged or discount percentage charged.

The present invention creates a risk offset, which is the amount of RTP FET transaction totals flowing from the card terminal 26 to the issuer bank 16, which reduces the amount of the credit transaction funds flowing from the card terminal to the issuer bank.

Block 86 illustrates the advantage of the payment of the present invention for the merchant, merchant bank, issuer bank and service provider. Each of these entities benefits in one way or the other from the increased volume of electronic fund transfer transactions that occur in the place of a traditional cash transaction.

Although the present invention has been described as being particularly useful in allowing a customer to make payments against an account maintained by a service provider, it should be understood that the present invention has many other contemplated uses outside of bill payment utilizing cash. As an example, it is contemplated that the RTP card 18 could be given to a bank customer such that the customer is allowed to deposit money into the customer's account from any third party merchant having a card terminal. As another example, a charity could issue RTP cards and allow donors to deposit money into a general deposit account from any card terminal.

The use of the RTP card allows the large number of card terminals located worldwide to be used to apply cash, credit card or debit card payments to a customer's account, regardless of what type of account the customer has. The RTP card can be issued to any customer regardless of the customer's credit history, since the RTP card is designed for depositing cash or a payment on the customer's account.

What is claimed is:

1. A method of processing a payment from a customer to a service provider, the method comprising the steps of:
issuing a real time payment (RTP) card to the customer, the RTP card including customer identification information and service provide identification information;
inputting the customer identification information and the service provider identification information at a third party merchant;
receiving a payment from the customer at the third party merchant and entering the payment amount at the third party merchant;
electronically transferring the payment amount, customer identification information and the service provider identification information to the service provider; and
crediting the customer's account at the service provider with the payment amount.

2. The method of claim 1 wherein the step of inputting the customer identification information and the service provider identification information includes swiping the RTP card through a credit card reader.

3. The method of claim 2 wherein a single RTP card is issued to a customer for a plurality of service providers, wherein the method comprises the step of identifying one of the plurality of service providers for payment at the card terminal of the third party merchant.

4. The method of claim 1 further comprising the step of generating a receipt for the payment to the customer from the third party merchant.

5. The method of claim 1 further comprising the steps of:
electronically transferring the customer identification information and the service provider identification information to an issuer bank associated with the service provider; and
generating and transferring authentication and acceptance message from the issuer bank to the third party merchant.

6. The method of claim 5 further comprising the step of:
electronically transferring the customer identification information and the service provider identification information to a merchant bank associated with the third party merchant, wherein the merchant bank electronically transfers the customer identification information and the service provider identification information to the issuer bank.

7. The method of claim 6 further comprising the step of:
crediting the account of the third party merchant at the merchant bank with the payment amount received by the third party merchant from the customer.

8. The method of claim 7 further comprising the step of:
crediting the account of the third party merchant at the merchant bank with a transaction fee.

9. The method of claim 8 further comprising the step of:
charging the service provider account with the transaction fee.

10. The method of claim 7 wherein the electronic transfer of information from the card terminal at the third party merchant and the merchant bank and the electronic transfer of information from the merchant bank to the service provider occurs over the currently available electronic finds transaction processing system.

11. The method of claim 1 wherein the card terminal at a third party merchant is an automated teller machine capable of receiving cash payments.

12. The method of claim 11 wherein the automated teller machine is capable of receiving cash payments, checks, debit or credit card payments.

13. The method of claim 1 wherein the third party merchant is not associated with the service provider.

14. The method of claim 1 wherein the step of receiving the payment from the customer includes receiving cash.

15. The method of claim 1 wherein the RTP card does not provide access to a deposit account of the customer and does not allow the customer to execute a credit transaction.

16. The method of claim 6 wherein the merchant bank applies the payment amount received at the third party merchant to a deposit total for the third party merchant such that the third party merchant receives the payment as a reduction of the deposit total for the third party merchant.

17. The method of processing a payment from a customer to a service provider, the method comprising the steps of:
issuing a real time payment (RTP) card to the customer, the RTP card including at least customer identification information and service provider identification information;
inputting the customer identification information and the service provider identification information into a card terminal at a third party merchant;
receiving a payment from the customer at the third party merchant and entering the payment amount into the card terminal;
electronically transferring the payment amount, customer identification information and service provider information to a merchant bank, wherein the merchant bank is associated with the third party merchant;
routing the payment amount, customer identification information and service provider identification to an issuer bank associated with the service provider;
confirming the customer identification information and service provider identification information at the issuer bank and recording the payment amount at the issuer bank;
providing authentication and approval for the transactions to the third party merchant from the issuer bank through the merchant bank; and
generating a receipt to the customer at the card terminal of the third party merchant confirming the payment received from the customer.

18. The method of claim 17 wherein the RTP card includes service provider identification information for a plurality of service providers.

19. The method of claim 18 wherein the plurality of service providers are each identified by the customer through a unique PIN number assigned to each of the plurality of service providers.

20. The method of claim 19 wherein the plurality of PIN numbers are printed on the RTP card.

21. The method of claim 17 wherein the card terminal is a credit card terminal and the step of inputting the customer identification information and the service provider identification information includes swiping the RTP card through the credit card terminal.

22. The method of claim 17 further comprising the step of:
charging the account of the service provider at the issuer bank for each transaction processed by the issuer bank.

23. The method of claim 22 further comprising the step of:
depositing to the account of the third party merchant a transaction fee for each transaction processed by the third party merchant.

24. The method of claim 17 further comprising the step of:
reducing the net deposit total of the third party merchant at the merchant bank by the payment amount received from the customer such that the third party merchant receives immediate payments for other credit and debit transactions.

25. The method of claim 17 wherein the payment receipt includes the payment amount and remaining balance for the customer.

26. The method of claim 17 wherein the third party merchant communicates to the merchant bank over a commercial electronic finds transaction processing network.

27. The method of claim 17 wherein the merchant bank communicates to the issuer bank over a commercial electronic funds transaction processing network.

28. The method of claim 17 wherein the payment terminal at the third party merchant is an automated teller machine.

29. The method of claim 17 wherein the RTP card is not associated with a bank account or credit card account.

30. The method of claim 17 wherein the payment from the customer is in the form of cash.

31. The method of claim 17 wherein the payment from the customer can be one of cash, a debit card or a credit card.

32. The method of claim 17 wherein the third party merchant is not associated with the service provider.

33. The method of claim 17 wherein the step of receiving payment from the customer includes encoding the payment into an electronic fund transaction prior to communicating the payment from the third party merchant to the merchant bank.
